(19) United States
(12) Patent Application Publication
(10) Pub. No.: US 2025/0374199 A1
(43) Pub. Date: Dec. 4, 2025

(54) UPLINK POWER CONTROL FOR DYNAMIC TDD AND SUBBAND FULL DUPLEX

(71) Applicant: MediaTek Singapore Pte. Ltd., Singapore (SG)

(72) Inventors: Sumaila Anning MAHAMA, Cambridge (GB); Mohammed S Aleabe AL-IMARI, Cambridge (GB); Jozsef Gabor NEMETH, Cambridge (GB)

(21) Appl. No.: 18/874,652

(22) PCT Filed: Jul. 19, 2023
(86) PCT No.: PCT/CN2023/108100

§ 371 Date: Dec. 13, 2024

Related U.S. Application Data
(60) Provisional application No. 63/371,107, filed on Aug. 11, 2022.

(51) Int. Cl. H04W 52/14; H04L 1/1607; H04W 72/115

(52) U.S. Cl. CPC H04W 52/146; H04L 1/1614; H04W 72/115

(57) ABSTRACT

Techniques pertaining to efficient uplink (UL) power control for dynamic time-division duplex (TDD) and subband full duplex (SBFD) in mobile communications are described. A user equipment (UE) performs an UL transmission with TDD in an SBFD network (including dynamic TDD and SBFD). The UE separately controls UL transmit powers used in performing the UL transmission on cross-link interference (CLI) slots and on non-CLI slots.

### CROSS REFERENCE TO RELATED PATENT APPLICATION(S)

The present disclosure is part of a non-provisional application claiming the priority benefit of U.S. Patent Application No. 63/371,107, filed 11 Aug. 2022, the content of which herein being incorporated by reference in its entirety.

### TECHNICAL FIELD

The present disclosure is generally related to mobile communications and, more particularly, to uplink (UL) power control for dynamic time-division duplex (TDD) and subband full duplex (SBFD) in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), the presence of slot level inter-base station (e.g., inter-gNB) cross-link interference (CLI) tends to result in a different interference distribution on the sets of slots that experience CLI (herein interchangeably referred to as “CLI slots”) and the sets of slots that experience no CLI (herein interchangeably referred to as non-CLI slots ”). Typically, the non-CLI slots tend to experience only co-channel interference (CCI), whereas the CLI slots tend to experience both CCI and CLI. Moreover, high interference can result in low signal-to-interference-and-noise ratio (SINR) on CLI slots. Accordingly, it would be beneficial to enable separate uplink (UL) power control loops for CLI slots and non-CLI slots to increase UL SINR on CLI slots as well as avoid transmission (Tx) power wastage on non-CLI slots. Therefore, there is a need for a solution of UL power control for dynamic TDD and SBFD in mobile communications to provide separate UL power control loops for CLI slots and non-CLI slots, thereby achieving good UL performance in the presence of inter-gNB CLI.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving UL power control for dynamic TDD and SBFD in mobile communications. It is believed that implementations of various proposed schemes in accordance with the present disclosure may address or otherwise alleviate issues described herein.

In one aspect, a method may involve a user equipment (UE) performing an UL transmission with TDD in an SBFD network (including dynamic TDD and SBFD). The method may also involve the UE separately controlling UL transmit powers used in performing the UL transmission on CLI slots and on non-CLI slots.

In another aspect, a method may involve a UE performing a sounding reference signal (SRS) transmission with TDD in an SBFD network (including dynamic TDD and SBFD). The method may also involve the UE separately controlling UL transmit powers used in performing the SRS transmission on CLI slots and on non-CLI slots.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario in which a proposed scheme in accordance with the present disclosure may be implemented.

FIG. 3 is a diagram of an example scenario in which a proposed scheme in accordance with the present disclosure may be implemented.

FIG. 4 is a diagram of an example scenario in which a proposed scheme in accordance with the present disclosure may be implemented.

FIG. 5 is a diagram of an example scenario in which a proposed scheme in accordance with the present disclosure may be implemented.

FIG. 6 is a diagram of an example scenario in which a proposed scheme in accordance with the present disclosure may be implemented.

FIG. 7 is a diagram of an example scenario in which a proposed scheme in accordance with the present disclosure may be implemented.

FIG. 8 is a diagram of an example scenario in which a proposed scheme in accordance with the present disclosure may be implemented.

FIG. 9 is a block diagram of an example communication system in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UL power control for dynamic TDD and SBFD in mobile communications. According to the present disclosure, a number of possible solutions may be implemented separately or jointly. That is, although these possible solutions may be described below separately, two or more of these possible solutions may be implemented in one combination or another.

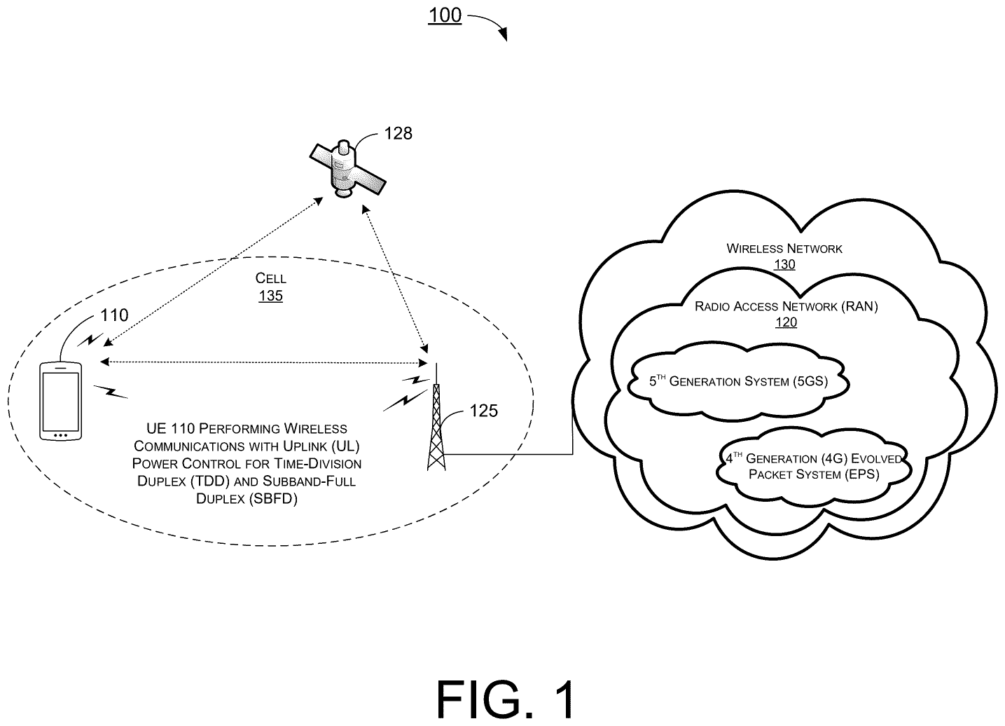

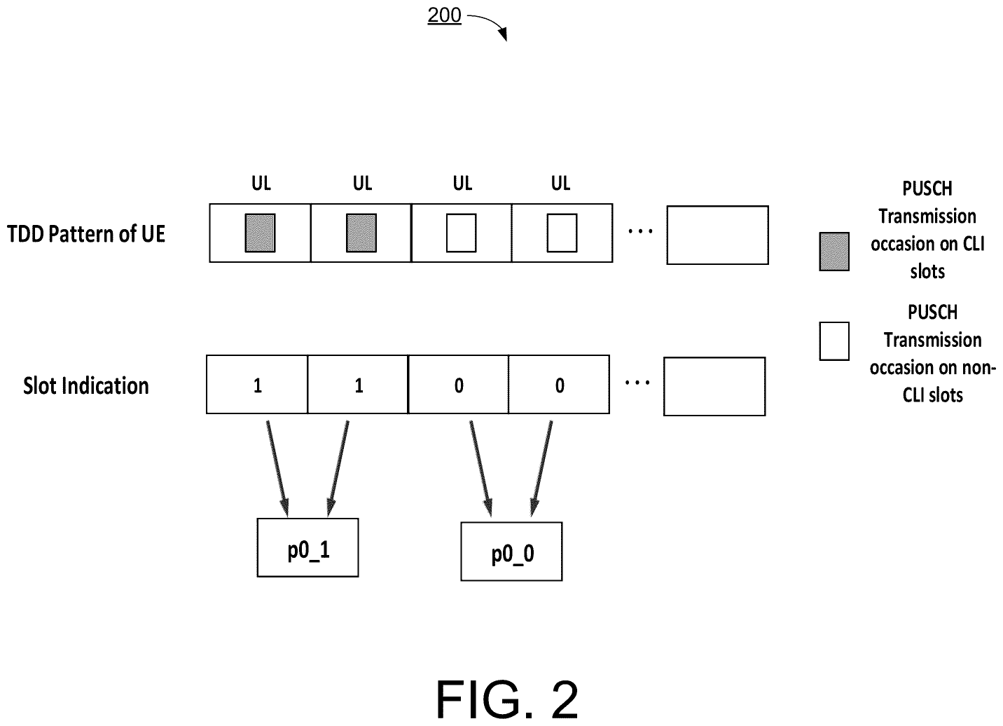

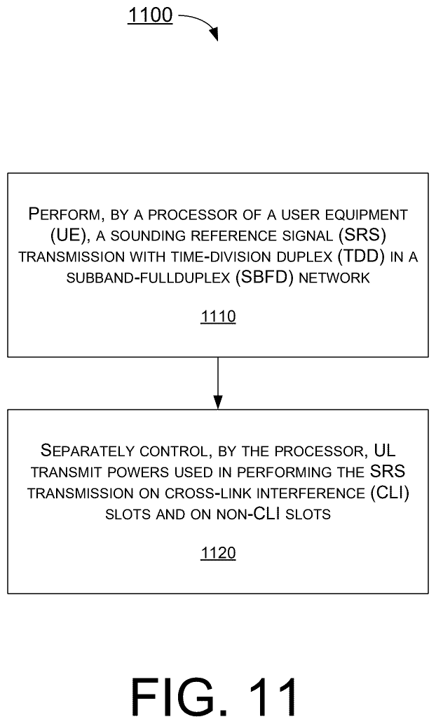

FIG. 1 illustrates an example network environment 100 in which various solutions and schemes in accordance with the present disclosure may be implemented. FIG. 2˜FIG. 11 illustrate examples of implementation of various proposed schemes in network environment 100 in accordance with the present disclosure. The following description of various proposed schemes is provided with reference to FIG. 1˜FIG. 11.

Referring to FIG. 1, network environment 100 may involve a UE 110 in wireless communication with a radio access network (RAN) 120 (e.g., a 5G NR mobile network or another type of network such as an NTN). UE 110 may be in coverage of a cell 135 and in wireless communication with RAN 120 via a base station or terrestrial network node 125 (e.g., an eNB, gNB or transmit-receive point (TRP)) and/or via a satellite or non-terrestrial network node 128. RAN 120 may be a part of a network 130. In network environment 100, UE 110 and network 130 (via terrestrial network node 125 or non-terrestrial network node 128 of RAN 120) may implement various schemes pertaining to UL power control for dynamic TDD and SBFD in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

With respect to configured grant (CG) physical uplink shared channel (PUSCH) transmissions, in wireless communications according to current 3GPP specification, the UE-specific power level for performing a CG PUSCH transmission (P_{0_UE_PUSCH,b,f,c}(j)) is configured semi-statically by radio resource control (RRC) signaling. For systems with CLI, both CLI and non-CLI slots may exist within a configured grant. The same configured P_{0_UE_PUSCH,b,f,c}(j) value is applied for both CLI and non-CLI slots. However, this semi-static power control is not sufficient to handle the additional interference on CLI slots. Thus, there is an issue in that the same configured uplink (UL) power control loop is applied for both CLI and non-CLI slots in CG PUSCH transmission.

With respect to dynamic grant (DG) PUSCH transmissions, there are three different cases in wireless communications according to current 3GPP specification. In case of dynamic grant without repetition and with absolute mode closed loop parameter, existing UL power control is capable of handling inter-gNB CLI dynamic grant transmissions. In case of dynamic grant without repetition and with accumulation mode closed loop parameter, there is an issue in that, if accumulation is enabled for the closed loop parameter, transmit power control (TPC) commands are accumulated over previous PUSCH transmission occasions, which can be in CLI or non-CLI slots. In case of dynamic grant with repetition, there is an issue in that the open loop and closed loop parameters are applicable to all the repetitions regardless of the slot type (CLI or non-CLI).

FIG. 2 illustrates an example scenario 200 in which a proposed scheme in accordance with the present disclosure may be implemented. Scenario 200 may pertain to CG PUSCH transmissions under the proposed scheme. As stated above, according to current 3GPP specification, the same configured UL power control is applied to both CLI slots and non-CLI slots in CG PUSCH transmissions. Under the proposed scheme, to address this issue, two UL power control loops may be utilized for CG PUSCH transmissions. That is, two open loop power control parameters or CG PUSCH transmissions may be defined. For instance, the two open loop power control parameters may be provided per CG PUSCH configuration. Alternatively, or additionally, each open loop power control parameter may be applied to a specific set of slots. Alternatively, or additionally, the two open loop power control parameters may be provided by two instances of the p0-NominalWithoutGrant information element (which is related to cell-specific p0 value for CG PUSCH and is applicable to all UEs within a cell) within the PUSCH-PowerControl parameter structure. For instance, an additional parameter p0-NominalWithoutGrant2 may be defined within the PUSCH-PowerControl parameter structure. Moreover, under the proposed scheme, the two open loop power parameters may be provided by two instances of the p0 information element from a specific instance of p0-PUSCH-AlphaSet within the PUSCH-PowerControl parameter structure. For instance, an additional parameter p02 may be defined within the PUSCH-PowerControl parameter structure.

Under the proposed scheme, with respect to CG PUSCH transmissions, the sets of slots, where each open loop power control parameter is applied, may be indicated to UE 110 by a higher-layer parameter. Alternatively, or additionally, a bitmap may be used to indicate the sets of slots to UE 110. For instance, for set(s) of slots with bit value=0, UE 110 may use one open loop power control parameter; and for set(s) of slots with bit value=1, UE 110 may use the other open loop power control parameter. Alternatively, or additionally, each open loop power control may be applied to a specific sets of symbols. Alternatively, or additionally, the sets of symbols, where each open loop power control parameter is applied, may be indicated to UE 110 by a higher-layer parameter. Alternatively, or additionally, a bitmap may be used to indicate the sets of symbols to UE 110. For instance, for sets of symbols with bit value=0, UE 110 may use one open loop power control parameter; and for sets of symbols with bit value=1, UE 110 may use the other open loop power control parameter.

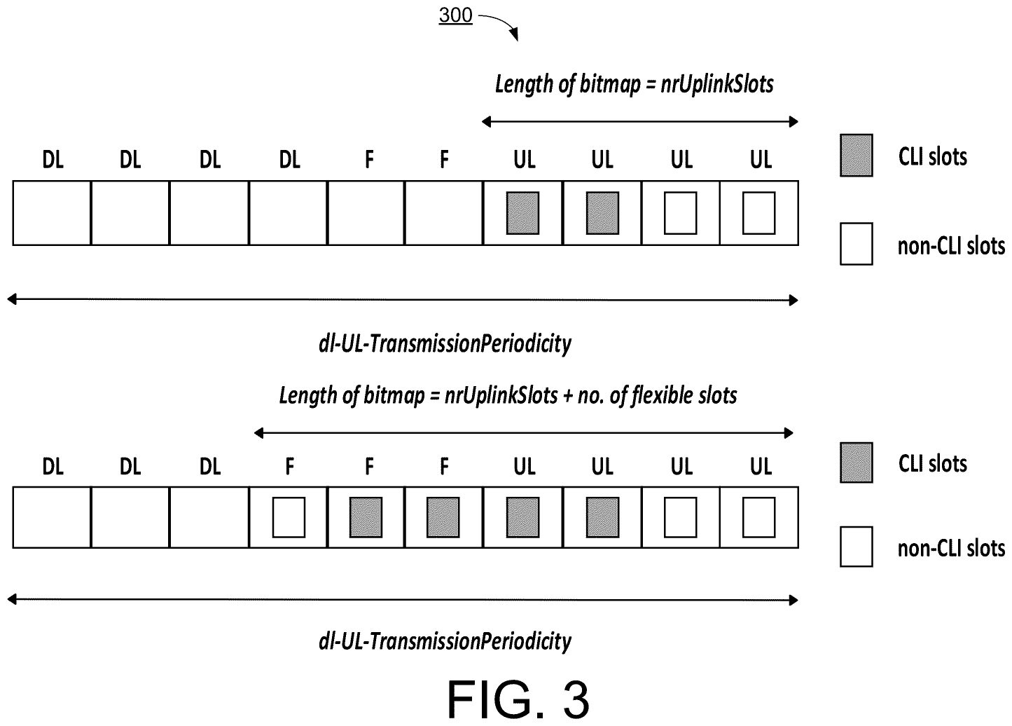

FIG. 3 illustrates an example scenario 300 in which a proposed scheme in accordance with the present disclosure may be implemented. Scenario 300 may pertain to CG PUSCH transmissions under the proposed scheme. Under the proposed scheme, with respect to CG PUSCH transmissions, a bitmap may be defined for UL slots configured by a higher-layer parameter tdd-UL-DL-ConfigurationCommon. Alternatively, or additionally, the bitmap may be provided per CG PUSCH configuration. Alternatively, or additionally, the length of the bitmap may be given by the number of UL slots signaled by tdd-UL-DL-ConfigurationCommon (l=nrofUplinkSlots). Under the proposed scheme, the bit value may be determined by comparing the set of slots of two base stations. For instance, bit value=0 may represent the set of slots indicated as UL in both base stations, and bit value=1 may represent the set of slots indicated as UL in one base station and DL in the other base station. Under the proposed scheme, the bitmap may be defined for UL slots and flexible slots configured by the higher-layer parameter tdd-UL-DL-ConfigurationCommon. Moreover, the length of the bitmap may be given by the sum of UL slots and flexible slots configured by tdd-UL-DL-ConfigurationCommon. Additionally, the definition of “UL slots” may include any slot that is partially UL. Furthermore, the definition of “flexible slots” may include any slot that is partially DL and partially flexible.

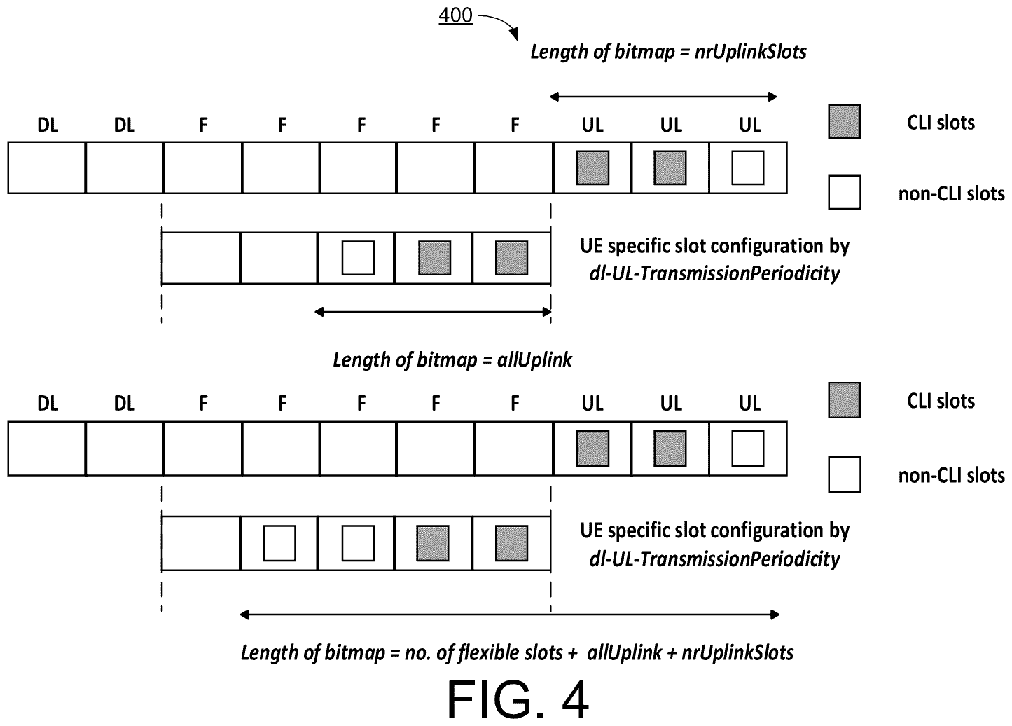

FIG. 4 illustrates an example scenario 400 in which a proposed scheme in accordance with the present disclosure may be implemented. Scenario 400 may pertain to CG PUSCH transmissions under the proposed scheme. Under the proposed scheme, a bitmap may be defined for UL slots configured by higher-layer parameters tdd-UL-DL-ConfigurationCommon and tdd-UL-DL-ConfigurationDedicated. Alternatively, or additionally, the length of the bitmap may be given by the sum of UL slots configured by tdd-UL-DL-ConfigurationCommon and tdd-UL-DL-ConfigurationDedicated. Alternatively, or additionally, the bitmap may be defined for all UL and flexible slots configured by higher-layer parameters tdd-UL-DL-ConfigurationCommon and tdd-UL-DL-ConfigurationDedicated. Moreover, the length of the bitmap may be given by the sum of UL slots and flexible slots configured by tdd-UL-DL-ConfigurationCommon and tdd-UL-DL-ConfigurationDedicated.

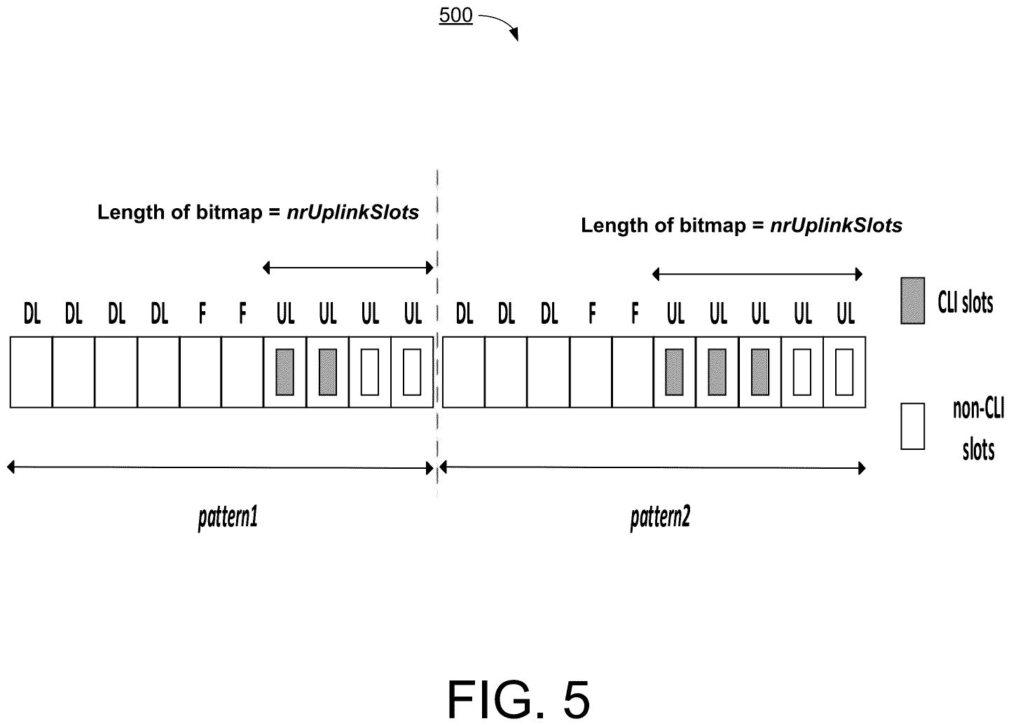

FIG. 5 illustrates an example scenario 500 in which a proposed scheme in accordance with the present disclosure may be implemented. Scenario 500 may pertain to CG PUSCH transmissions under the proposed scheme. Under the proposed scheme, a bitmap may be defined for UL slots when both pattern1 and pattern2 are configured by the higher-layer parameter tdd-UL-DL-ConfigurationCommon. Alternatively, or additionally, the bitmap may be provided per CG PUSCH configuration when both patternl and pattern2 are configured. Alternatively, or additionally, a separate bitmap may be defined for each UL/DL pattern. For instance, a higher-layer parameter may be defined as the bitmap for pattern1, and the length of the bitmap for pattern may be given by the number of UL-only slots in pattern1. Moreover, a higher-layer parameter may be defined as the bitmap for pattern2, and the length of the bitmap for pattern2 may be given by the number of UL-only slots in pattern2. Under the proposed scheme, the bitmap defined for both UL and flexible slots, as described above, may be adopted for pattern1 and pattern2.

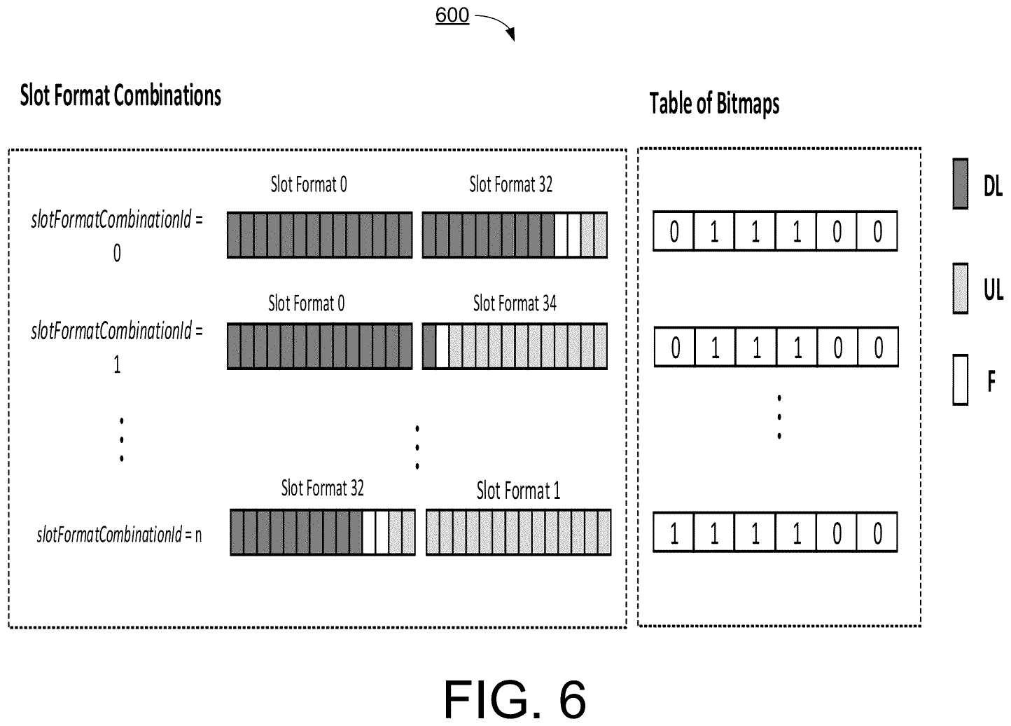

FIG. 6 illustrates an example scenario 600 in which a proposed scheme in accordance with the present disclosure may be implemented. Scenario 600 may pertain to CG PUSCH transmissions under the proposed scheme. Under the proposed scheme, a bitmap may be defined for flexible slots that are dynamically reconfigured by Layer-1 signaling using the SlotFormatIndicator parameter structure. Alternatively, or additionally, the bitmap may be provided per Slot Format Combination. Under the proposed scheme, the bitmap may have two parts, as follows: the first part of the bitmap may be defined based on slots that are dynamically reconfigured by Layer-1 signaling, and the second part of the bitmap may be defined based on CG PUSCH configuration by higher-layer parameters. Moreover, a length of the first part of the bitmap may be equal to the number of Slot Formats within each Slot Format Combination.

Under a proposed scheme in accordance with the present disclosure with respect to a bitmap defined for CG PUSCH transmissions, the bitmap may be indicated to UE 110 via higher-layer parameter(s). For instance, the defined bitmap may be directly indicated to UE 110 by a higher-layer parameter. Alternatively, or additionally, a table of bitmaps may be defined for CG PUSCH configured by a higher-layer parameter. For instance, the rows of the bitmap table may represent the respective bitmap of a corresponding CG PUSCH configuration of a plurality of CG PUSCH configurations and may be indicated by a higher-layer parameter. Alternatively, or additionally, a given bitmap may be indicated to UE 110 by a higher-layer parameter which serves as a pointer to a row in the bitmap table. Alternatively, or additionally, a new parameter may be defined and indicated to UE 110 by Layer-1 signaling to serve as a pointer to a row in the bitmap table.

Under the proposed scheme, a part of the bitmap that is reconfigured, as described above, may be indicated to UE 110 via Layer-1 signaling. Alternatively, or additionally, the part of the bitmap that is dynamically reconfigured by Layer-1 signaling may be directly indicated to UE 110 by Layer-1 signaling. For instance, the rows of the bitmap table may represent the respective bitmap of a corresponding CG PUSCH configuration of a plurality of CG PUSCH configurations and may be indicated by Layer-1 signaling. Alternatively, or additionally, a given bitmap may be indicated to UE 110 by Layer-1 signaling which serves as a pointer to a row in the bitmap table.

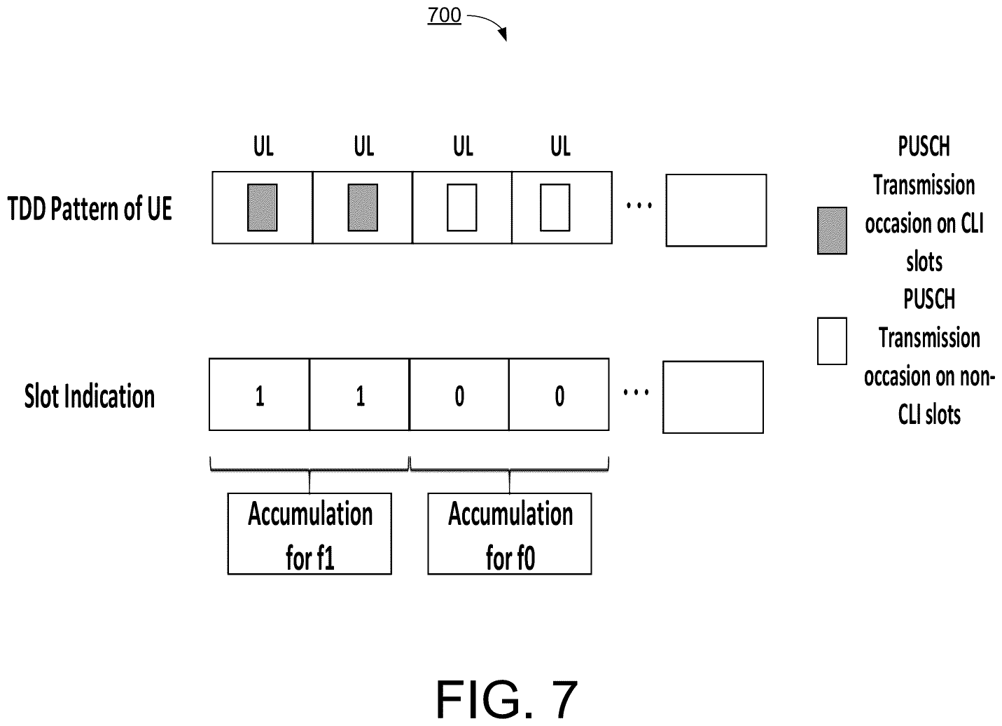

FIG. 7 illustrates an example scenario 700 in which a proposed scheme in accordance with the present disclosure may be implemented. Scenario 700 may pertain to dynamic grant (DG) PUSCH transmissions without repetition under the proposed scheme. As stated above, according to current 3GPP specification, if accumulation is enabled for the closed loop power control parameter, TPC commands are accumulated over previous PUSCH transmission occasions, which can be in CLI or non-CLI slots. Under the proposed scheme, to address this issue, two TPC command accumulations for DG PUSCH without repetition may be defined with accumulation enabled. For instance, each TPC command accumulation may be applied to one or more specific sets of slots. The sets of slots, where each TPC command accumulation is applied, may be indicated to UE 110 by a higher-layer parameter. Alternatively, or additionally, the sets of slots, where each TPC command accumulation is applied, may be indicated to UE 110 by Layer-1 signaling. For instance, a new parameter may be defined and indicated to UE 110 via Layer-1 signaling. Under the proposed scheme, a bitmap may be used to indicate the sets of slots where each TPC command accumulation is applied. For instance, for set(s) of slots with a bit value=0, UE 110 may apply one TPC command accumulation; and for set(s) of slots with a bit value=1, UE 110 may apply the other TPC command accumulation.

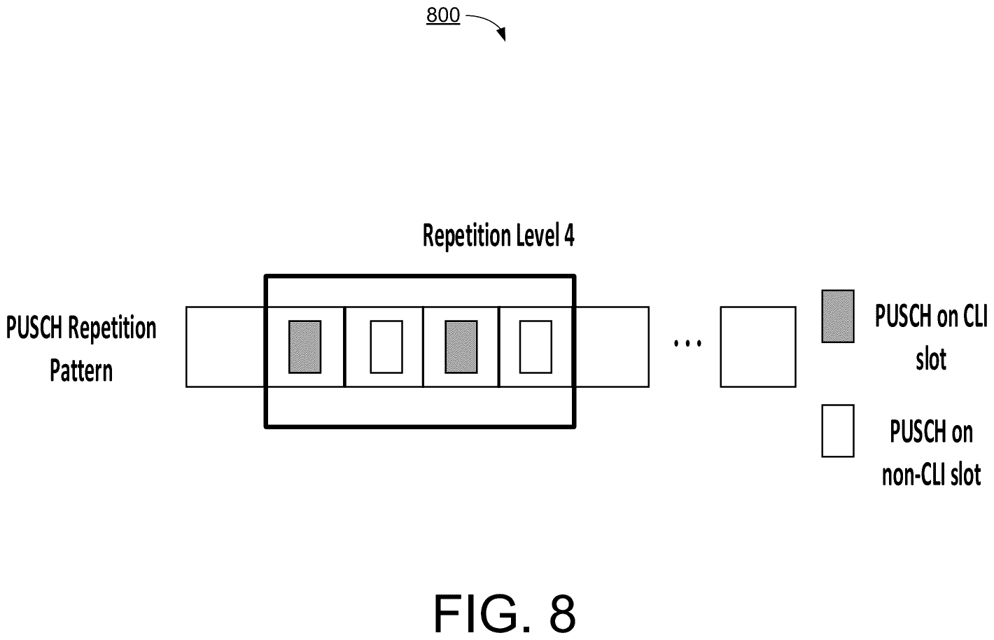

FIG. 8 illustrates an example scenario 800 in which a proposed scheme in accordance with the present disclosure may be implemented. Scenario 800 may pertain to DG PUSCH transmissions with repetition under the proposed scheme. According to current 3GPP specification, the same open loop power control parameters are applicable to all the slots within a DG PUSCH repetition regardless of the slot type. Under the proposed scheme, to address this issue, two UL power control loops may be utilized for DG PUSCH transmissions with repetition. For instance, two open loop power control parameters may be defined for DG PUSCH with repetition. The two open loop power control parameters may be provided per DG PUSCH repetition pattern. Additionally, each open loop power control parameter may be applied to one or more specific sets of slots within the DG PUSCH repetition. In some implementations, the set(s) of slots within the DG PUSCH repetition, where each open loop power control parameter is applied, may be indicated to UE 110 by a higher-layer parameter. Alternatively, or additionally, the set(s) of slots within the DG PUSCH repetition, where each open loop power control parameter is applied, may be indicated to UE 110 by Layer-1 signaling. In such cases, a new parameter may be defined and indicated to UE 110 via Layer-1 signaling. Under the proposed scheme, a bitmap may be used to indicate the sets of slots within the DG PUSCH repetition. For instance, for set(s) of slots with a bit value=0, UE 110 may apply one open loop power control parameter; and for set(s) of slots with a bit value=1, UE 110 may apply the other open loop power control parameter. Under the proposed scheme, the length of the bitmap indicated by Layer-1 signaling may be given by the number of slots within the DG PUSCH repetition.

According to current 3GPP specification, the same TPC command accumulation is maintained for all slots within a DG PUSCH repetition regardless of the slot type. Under the proposed scheme, to address this issue, two TPC command accumulations may be defined for DG PUSCH with repetition. For instance, each TPC command accumulation may be applied to one or more specific sets of slots within the DG PUSCH repetition. The set(s) of slots within the repetition, where each TPC command accumulation is applied, may be indicated to UE 110 by a higher-layer parameter. Alternatively, or additionally, the set(s) of slots within the repetition, where each TPC command accumulation is applied, may be indicated to UE 110 by Layer-1 signaling. In such cases, a new parameter may be defined and indicated to UE 110 via Layer-1 signaling. Under the proposed scheme, a bitmap may be used to indicate the sets of slots within the DG PUSCH repetition. For instance, for set(s) of slots with a bit value=0, UE 110 may apply one TPC command accumulation; and for set(s) of slots with a bit value=1, UE 110 may apply the other TPC command accumulation. Under the proposed scheme, the length of the bitmap indicated by Layer-1 signaling may be given by the number of slots within the DG PUSCH repetition.

Under a proposed scheme in accordance with the present disclosure with respect to a bitmap defined for DG PUSCH transmissions, the bitmap may be indicated to UE 110 via higher-layer parameter(s). For instance, the defined bitmap may be directly indicated to UE 110 by a higher-layer parameter. In such cases, UE 110 may use the bitmap to determine the bit value of a scheduled DG PUSCH transmission with repetition. Alternatively, or additionally, UE 110 may select the bitmap for DG PUSCH transmission with repetition from the defined bitmap. Under the proposed scheme, the defined bitmap for DG PUSCH may be indicated to UE 110 via Layer-1 signaling. For instance, the defined bitmap for DG PUSCH transmissions without repetition may be directly indicated to UE 110 via Layer-1 signaling. Moreover, the defined bitmap for DG PUSCH with repetition may be directly indicated to UE 110 via Layer-1 signaling.

With respect to physical uplink control channel (PUCCH) transmissions, there are four different cases in wireless communications according to current 3GPP specification. In case of periodic PUCCH transmissions, there is an issue in that the same UL power control loop is applied for periodic PUCCH transmissions, which may be configured in a CLI or non-CLI slot. In case of semi-persistent PUCCH transmissions, there is an issue in that the same UL power control loop is applied for PUCCH transmissions triggered by a single medium access control (MAC) control element (CE), which may be configured in a CLI or non-CLI slot. In case of aperiodic PUCCH transmissions, there is an issue in that an absolute model is not defined for the closed loop parameter (although accumulation is always enabled), and TPC commands are accumulated over previous PUCCH transmission occasions, which may be in CLI or non-CLI slots. In case of PUCCH repetition, there is an issue in that the same open loop and closed loop parameters are applied for all repetitions regardless of the slot type (CLI or non-CLI).

As stated above, according to current 3GPP specification, the same UL power control loop is applied for periodic PUCCH transmissions, which may be configured in a CLI or non-CLI slot. Under a proposed scheme in accordance with the present disclosure, to address this issue, two UL power control loops may be defined for periodic PUCCH transmissions. For instance, two open loop power control parameters for periodic PUCCH transmissions may be defined. The two open loop power control parameters may be provided per periodic PUCCH transmission. Alternatively, or additionally, the two open loop power control parameters may be provided by two instances of the p0-nominal information element within the PUCCH-ConfigCommon parameter structure. Moreover, an additional parameter p0-nominal2 may be defined within the PUCCH-ConfigCommon parameter structure. Under the proposed scheme, the two open loop power control parameters may be provided by two instances of the p0-PUCCH-Value information element from a specific instance of p0-PUCCH within the PUCCH-PowerControl parameter structure. Moreover, an additional parameter p0-PUCCH-Value2 may be defined within the PUCCH-PowerControl parameter structure. Under the proposed scheme, each open loop power control parameter may be applied to one or more specific sets of slots. The set(s) of slots, where each open loop power control parameter is applied, may be indicated to UE 110 via a higher-layer parameter. Alternatively, or additionally, a bitmap may be used to indicate the sets of slots to UE 110. For instance, a bitmap similar to the bitmap described above with respect to CG PUSCH transmissions may be used to indicate the sets of slots.

As stated above, according to current 3GPP specification, the same UL power control loop is applied for semi-persistent PUCCH transmissions, which may be configured in a CLI or non-CLI slot. Under a proposed scheme in accordance with the present disclosure, to address this issue, two UL power control loops may be defined for semi-persistent PUCCH transmissions. For instance, two open loop power control parameters for semi-persistent PUCCH transmissions may be defined. The two open loop power control parameters may be provided per semi-persistent PUCCH transmission. Alternatively, or additionally, the two open loop power control parameters may be provided by two instances of the p0-nominal information element within the PUCCH-ConfigCommon parameter structure. Moreover, an additional parameter p0-nominal2 may be defined within the PUCCH-ConfigCommon parameter structure. Under the proposed scheme, the two open loop power control parameters may be provided by two instances of the p0-PUCCH-Value information element from a specific instance of p0-PUCCH within the PUCCH-PowerControl parameter structure. Moreover, an additional parameter p0-PUCCH-Value2 may be defined within the PUCCH-PowerControl parameter structure. Under the proposed scheme, each open loop power control parameter may be applied to one or more specific sets of slots. The set(s) of slots, where each open loop power control parameter is applied, may be indicated to UE 110 via a higher-layer parameter. Alternatively, or additionally, a bitmap may be used to indicate the set(s) of slots to UE 110. For instance, a bitmap similar to the bitmap described above with respect to CG PUSCH transmissions may be used to indicate the sets of slots.

As stated above, according to current 3GPP specification, an absolute model is not defined for the closed loop parameter, and TPC commands are accumulated over previous PUCCH transmission occasions, which can be in CLI or non-CLI slots. Under a proposed scheme in accordance with the present disclosure, to address this issue, two TPC command accumulations may be defined for aperiodic PUCCH transmissions. For instance, two TPC command accumulations for aperiodic PUCCH transmissions with accumulation enabled may be defined. Each TPC command accumulation may be applied to one or more specific sets of slots. The set(s) of slots, where each TPC command accumulation is applied, may be indicated to UE 110 via Layer-1 signaling. For instance, a new parameter may be defined and indicated to UE 110 via Layer-1 signaling. Alternatively, or additionally, a bitmap may be used to indicate the set(s) of slots where each TPC command accumulation is applied. For instance, for set(s) of slots with a bit value=0, UE 110 may apply one TPC command accumulation; and for set(s) of slots with a bit value=1, UE 110 may apply the other TPC command accumulation.

As stated above, according to current 3GPP specification, the same open loop power control parameter(s) may be applied to all the slots within a PUCCH repetition regardless of the slot type. Under a proposed scheme in accordance with the present disclosure, to address this issue, two UL power control loops may be defined for PUCCH transmissions with repetition. For instance, two open loop power control parameters for PUCCH transmissions with repetition may be defined. The two open loop power control parameters may be provided per PUCCH repetition pattern. Moreover, each open loop power control parameter may be applied to one or more specific sets of slots within the PUCCH repetition. In some cases, a set of slots within the PUCCH repetition, where each open loop power control parameter is applied, may be indicated to UE 110 via a higher-layer parameter. Alternatively, or additionally, a set of slots within the PUCCH repetition, where each open loop power control parameter is applied, may be indicated to UE 110 via Layer-1 signaling. For instance, a new parameter may be defined and indicated to UE 110 via Layer-1 signaling. Alternatively, or additionally, a bitmap may be used to indicate the set(s) of slots within the PUCCH repetition. For instance, for set(s) of slots with a bit value=0, UE 110 may apply one open loop power control parameter; and for set(s) of slots with a bit value=1, UE 110 may apply the other open loop power control parameter. Moreover, the length of the bitmap indicated to UE 110 via Layer-1 signaling may be given by the number of slots within the PUCCH repetition.

As stated above, according to current 3GPP specification, the same TPC command accumulation is maintained for all slots within a PUCCH repetition regardless of the slot type. Under a proposed scheme in accordance with the present disclosure, to address this issue, two TPC command accumulations may be defined for PUCCH transmissions with repetition. For instance, two TPC command accumulations for PUCCH transmissions with repetition may be defined. Each TPC command accumulation may be applied to one or more specific sets of slots within a PUCCH repetition. The set(s) of slots within the PUCCH repetition, where each TPC command accumulation is applied, may be indicated to UE 110 via a higher-layer parameter. Alternatively, or additionally, the set(s) of slots within the PUCCH repetition, where each TPC command accumulation is applied, may be indicated to UE 110 via Layer-1 signaling. For instance, a new parameter may be defined and indicated to UE 110 via Layer-1 signaling. Alternatively, or additionally, a bitmap may be used to indicate the set(s) of slots within the PUCCH repetition. For instance, for set(s) of slots with a bit value=0, UE 110 may apply one TPC command accumulation; and for set(s) of slots with a bit value=1, UE 110 may apply the other TPC command accumulation. Moreover, the length of the bitmap indicated to UE 110 via Layer-1 signaling may be given by the number of slots within the PUCCH repetition.

Under a proposed scheme in accordance with the present disclosure with respect to a bitmap defined for periodic PUCCH transmissions, the bitmap may be indicated to UE 110 via higher-layer parameter(s). For instance, the defined bitmap may be directly indicated to UE 110 by a higher-layer parameter. Alternatively, or additionally, a table of bitmaps defined as described above may be used to indicate the sets of slots for periodic PUCCH transmissions. For instance, the rows of the bitmap table may represent the bitmap for periodic PUCCH configurations. Under the proposed scheme, a bitmap may be indicated to UE 110 via a higher-layer parameter which serves as a pointer to a row in the bitmap table. Moreover, a new parameter may be defined and indicated to UE 110 by Layer-1 signaling to serve as a pointer to a row in the bitmap table. Alternatively, or additionally, a bitmap defined and described above with respect to CG PUSCH transmissions may be indicated via a high-layer parameter for semi-persistent PUCCH transmissions. In some cases, the defined bitmap may be directly indicated to UE 110 by a higher-layer parameter. Alternatively, or additionally, a table of bitmap defined and described above with respect to CG PUSCH transmissions may be used to indicate the sets of slots for semi-persistent PUCCH transmissions. For instance, the rows of the bitmap table may represent the bitmap for semi-persistent PUCCH configurations. Moreover, a bitmap may be indicated to UE 110 by a higher-layer parameter which serves as a pointer to a row in the bitmap table. Alternatively, or additionally, a new parameter may be defined and indicated to UE 110 by Layer-1 signaling to serve as a pointer to a row in the bitmap table.

Under a proposed scheme in accordance with the present disclosure with respect to a bitmap defined for aperiodic PUCCH transmissions, a bitmap defined and described above with respect to CG PUSCH transmissions may be indicated to UE 110 via higher-layer parameter(s) for aperiodic PUCCH. In some cases, the defined bitmap may be directly indicated to UE 110 via a higher-layer parameter. For instance, UE 110 may use the bitmap to determine the bit value of a scheduled aperiodic PUCCH transmission. Alternatively, or additionally, the defined bitmap may be directly indicated to UE 110 by Layer-1 signaling. Under the proposed scheme, a bitmap defined and described above with respect to CG PUSCH transmissions may be indicated to UE 110 via higher-layer parameter(s) for PUCCH transmissions with repetition. In some cases, the defined bitmap may be directly indicated to UE 110 via a higher-layer parameter. For instance, UE 110 may use the bitmap to determine the bit value of a scheduled PUCCH transmission. Alternatively, or additionally, the defined bitmap may be directly indicated to UE 110 by Layer-1 signaling.

With respect to SRS transmissions, there are three different cases in wireless communications according to current 3GPP specification. In case of periodic SRS transmissions, there is an issue in that the same UL power control loop is applied for periodic SRS transmissions, which may be configured in a CLI or non-CLI slot. In case of semi-persistent SRS transmissions, there is an issue in that the same UL power control loop is applied for SRS transmissions triggered by a single MAC CE, which may be configured in a CLI or non-CLI slot. In case of aperiodic SRS transmissions, for the scenario in which the closed loop power control parameter for PUSCH can be reused by SRS, the existing UL power control is capable of handling inter-gNB for aperiodic SRS transmissions. In case of aperiodic SRS transmission, for the scenario in which the closed loop power control parameter for PUSCH can be reused by SRS, the existing UL power control is capable of handling inter-gNB CLI when TPC accumulation is disabled for PUSCH. However, the issues described above for PUSCH power control with TPC accumulation enabled will apply to SRS transmission when the closed loop power control for PUSCH is reused by SRS. For aperiodic transmissions with the absolute mode closed loop parameter, the existing UL power control is capable of handling inter-gNB for aperiodic SRS transmissions. However, there is an issue in that, if a separate closed loop parameter is needed for SRS and TPC accumulation is enabled, TPC commands are accumulated over previous SRS transmission occasions, which can be in CLI or non-CLI slots.

As stated above, according to current 3GPP specification, the same UL power control loop is applied for periodic SRS transmissions, which may be configured in CLI or non-CLI slots. Under a proposed scheme in accordance with the present disclosure, to address this issue, two UL power control loops may be defined for periodic SRS transmissions. For instance, two open loop power control parameters for periodic SRS transmissions may be defined. The two open loop power control parameters may be provided per periodic SRS configuration. Alternatively, or additionally, the two open loop power control parameters may be provided via two instances of p0 (which is UE-specific power level for CG PUSCH) within the SRS-ResourceSet parameter structure. For instance, an additional parameter p02 may be defined within the SRS-ResourceSet parameter structure. Under the proposed scheme, each open loop power control parameter may be applied to one or more specific sets of slots. The set(s) of slots, where each open loop power control parameter is applied, may be indicated to UE 110 by a higher-layer parameter. Alternatively, or additionally, a bitmap may be used to indicate the sets of slots to UE 110. Alternatively, or additionally, a bitmap similar to the bitmap defined and described above with respect to CG PUCCH transmissions may be used to indicate the sets of slots.

As stated above, according to current 3GPP specification, the same UL power control loop is applied for semi-persistent SRS transmissions, which may be configured in CLI or non-CLI slots. Under a proposed scheme in accordance with the present disclosure, to address this issue, two UL power control loops may be defined for semi-persistent SRS transmissions. For instance, two open loop power control parameters for semi-persistent SRS transmissions may be defined. The two open loop power control parameters may be provided per semi-persistent SRS configuration. Alternatively, or additionally, the two open loop power control parameters may be provided via two instances of p0 (which is UE-specific power level for CG PUSCH) within the SRS-ResourceSet parameter structure. For instance, an additional parameter p02 may be defined within the SRS-ResourceSet parameter structure. Under the proposed scheme, each open loop power control parameter may be applied to one or more specific sets of slots. The set(s) of slots, where each open loop power control parameter is applied, may be indicated to UE 110 by a higher-layer parameter. Alternatively, or additionally, a bitmap may be used to indicate the sets of slots to UE 110. Alternatively, or additionally, a bitmap similar to the bitmap defined and described above with respect to CG PUCCH transmissions may be used to indicate the sets of slots.

As stated above, according to current 3GPP specification, if a separate closed loop parameter is needed for SRS and TPC accumulation is enabled, TPC commands are accumulated over previous SRS transmission occasions, which can be in CLI or non-CLI slots. Under a proposed scheme in accordance with the present disclosure, to address this issue, two TPC command accumulations may be defined for SRS transmissions. For instance, two TPC command accumulations for aperiodic SRS transmissions with accumulation enabled may be defined. Each TPC command accumulation may be applied to one or more specific sets of slots. The set(s) of slots, where each TPC command accumulation is applied, may be indicated to UE 10 by a higher-layer parameter. Alternatively, or additionally, the set(s) of slots, where each TPC command accumulation is applied, may be indicated to UE 10 by Layer-1 signaling. For instance, a new Layer-1 parameter may be defined within the downlink control information (DCI) that schedules the SRS transmission. Alternatively, or additionally, a bitmap may be used to indicate the set(s) of slots where each TPC command accumulation is applied. For instance, for set(s) of slots with a bit value=0, UE 110 may apply one TPC command accumulation; and for set(s) of slots with a bit value=1, UE 110 may apply the other TPC command accumulation.

Under a proposed scheme in accordance with the present disclosure with respect to a bitmap defined for SRS transmissions, a bitmap defined and described above with respect to CG PUSCH transmissions may be indicated to UE 110 via higher-layer parameter(s) for periodic SRS transmissions. In some cases, the defined bitmap may be directly indicated to UE 110 via a higher-layer parameter. Alternatively, or additionally, a table of bitmaps defined and described above with respect to CG PUSCH transmissions may be used to indicate the sets of slots for periodic SRS transmissions. For instance, the rows of the bitmap table may represent the bitmap for periodic SRS configurations. Moreover, a bitmap may be indicated to UE 110 by a higher-layer parameter which serves as a pointer to a row in the bitmap table. Moreover, a new parameter may be defined and indicated to UE 110 by Layer-1 signaling to serve as a pointer to a row in the bitmap table.

Under the proposed scheme, the bitmap defined and described above with respect to CG PUSCH transmissions may be indicated by a higher-layer parameter for semi-persistent SRS transmissions. In some cases, the defined bitmap may be directly indicated to UE 110 via a higher-layer parameter. Alternatively, or additionally, a table of bitmaps defined and described above with respect to CG PUSCH transmissions may be used to indicate the sets of slots for semi-persistent SRS transmissions. For instance, the rows of the bitmap table may represent the bitmap for semi-persistent SRS configurations. Moreover, a bitmap may be indicated to UE 110 by a higher-layer parameter which serves as a pointer to a row in the bitmap table. Moreover, a new parameter may be defined and indicated to UE 110 by Layer-1 signaling to serve as a pointer to a row in the bitmap table.

Under the proposed scheme, the bitmap defined and described above with respect to CG PUSCH transmissions may be indicated by a higher-layer parameter for aperiodic SRS transmissions. In some cases, the defined bitmap may be directly indicated to UE 110 via a higher-layer parameter. For instance, UE 110 may use the bitmap to determine the bit value of a scheduled aperiodic SRS transmission. Alternatively, or additionally, the defined bitmap may be directly indicated to UE 110 b Layer-1 signaling.

### Illustrative Implementations

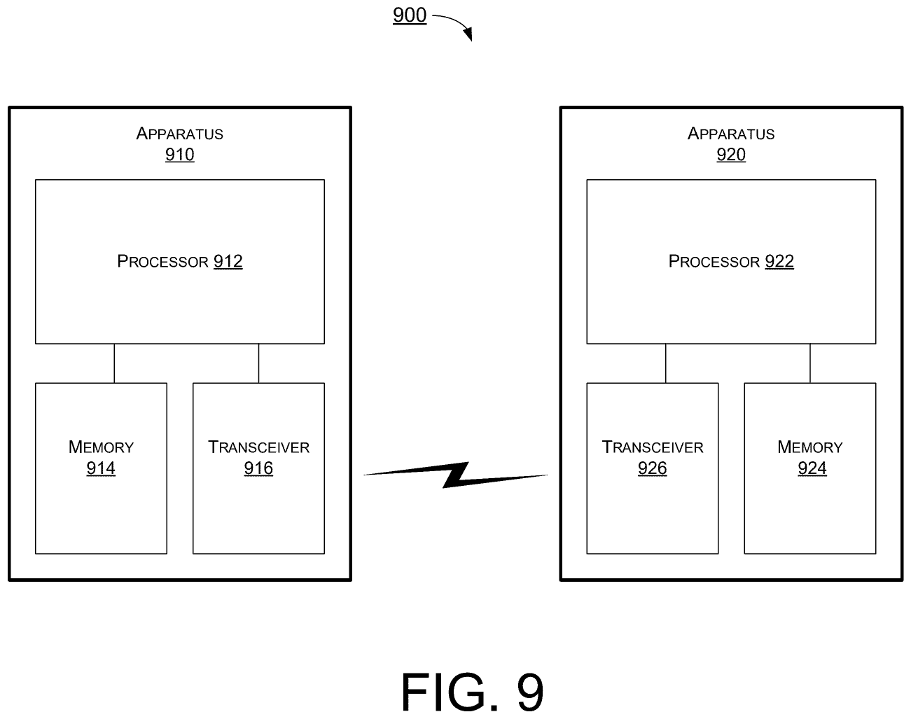

FIG. 9 illustrates an example communication system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to UL power control for dynamic TDD and SBFD in mobile communications, including the various schemes described above with respect to various proposed designs, concepts, schemes, systems and methods described above, including network environment 100, as well as processes described below.

Each of apparatus 910 and apparatus 920 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 910 and apparatus 920 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in an eNodeB in an LTE, LTE-Advanced or LTE-Advanced Pro network or in a gNB or TRP in a 5G network, an NR network or an IoT network.

In some implementations, each of apparatus 910 and apparatus 920 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 910 and apparatus 920 may be implemented in or as a network apparatus or a UE. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC or RISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to UL power control for dynamic TDD and SBFD in mobile communications in accordance with various implementations of the present disclosure.

In some implementations, apparatus 910 may also include a transceiver 916 coupled to processor 912. Transceiver 916 may be capable of wirelessly transmitting and receiving data. In some implementations, transceiver 916 may be capable of wirelessly communicating with different types of wireless networks of different radio access technologies (RATs). In some implementations, transceiver 916 may be equipped with a plurality of antenna ports (not shown) such as, for example, four antenna ports. That is, transceiver 916 may be equipped with multiple transmit antennas and multiple receive antennas for multiple-input multiple-output (MIMO) wireless communications. In some implementations, apparatus 920 may also include a transceiver 926 coupled to processor 922. Transceiver 926 may include a transceiver capable of wirelessly transmitting and receiving data. In some implementations, transceiver 926 may be capable of wirelessly communicating with different types of UEs/wireless networks of different RATs. In some implementations, transceiver 926 may be equipped with a plurality of antenna ports (not shown) such as, for example, four antenna ports. That is, transceiver 926 may be equipped with multiple transmit antennas and multiple receive antennas for MIMO wireless communications.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as a UE (e.g., UE 110), and apparatus 920, as a network node (e.g., terrestrial network node 125 or non-terrestrial network node 128) of a network (e.g., network 130 as a 5G/NR mobile network), is provided below in the context of example processes 1000 and 1100.

### Illustrative Processes

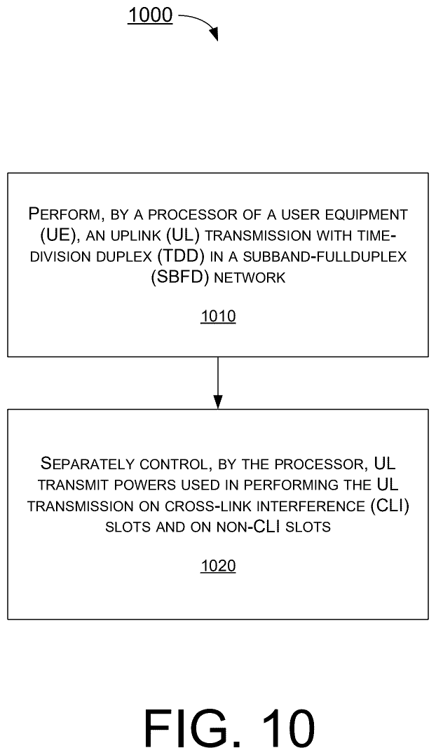

FIG. 10 illustrates an example process 1000 in accordance with an implementation of the present disclosure. Process 1000 may represent an aspect of implementing various proposed designs, concepts, schemes, systems and methods described above, whether partially or entirely, including those pertaining to those described above. More specifically, process 1000 may represent an aspect of the proposed concepts and schemes pertaining to UL power control for dynamic TDD and SBFD in mobile communications. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively in a different order. Furthermore, one or more of the blocks/sub-blocks of process 1000 may be executed iteratively. Process 1000 may be implemented by or in apparatus 910 and apparatus 920 as well as any variations thereof. Solely for illustrative purposes and without limiting the scope, process 1000 is described below in the context of apparatus 910 as a UE (e.g., UE 110) and apparatus 920 as a communication entity such as a network node or base station (e.g., terrestrial network node 125 or non-terrestrial network node 128) of a network (e.g., network 130 as a 5G/NR mobile network). Process 1000 may begin at block 1010.

At 1010, process 1000 may involve processor 912 of apparatus 910 performing, via transceiver 916, an uplink (UL) transmission with TDD in an SBFD network (e.g., with apparatus 920 in network 130), including dynamic TDD and SBFD. Process 1000 may proceed from 1010 to 1020.

At 1020, process 1000 may involve processor 912 separately controlling, via transceiver 916, UL transmit powers used in performing the UL transmission on CLI slots and on non-CLI slots.

In some implementations, UL transmission may include a CG PUSCH transmission.

In some implementations, two UL power control loops may be defined for the CG PUSCH transmission with two open loop power control parameters provided per CG PUSCH configuration. In such cases, each of the two open loop power control parameters may be applied to a specific set of slots among the CLI slots or the non-CLI slots. Moreover, one or more sets of slots among the CLI slots or the non-CLI slots, where each of the two open loop power control parameters is applied, may be indicated to apparatus 910 (e.g., via apparatus 920) by a higher-layer parameter or a bitmap. In some implementations, the bitmap may be defined for UL slots or flexible slots or both the UL slots and the flexible slots. Additionally, the bitmap may be provided per CG PUSCH configuration. Moreover, the bitmap may be indicated to apparatus 910 (e.g., via apparatus 920) by higher-layer parameters or Layer-1 signaling.

In some implementations, the UL transmission may include a DG PUSCH transmission with or without repetition.

In some implementations, two TPC command accumulations may be defined for the DG PUSCH transmission without repetition and with accumulation enabled. In such cases, the TPC command accumulations for the DG PUSCH may be reused in an SRS transmission in an event that a closed loop power control parameter is applied to the SRS transmission. Moreover, each of the two TPC command accumulations may be applied to a specific set of slots among the CLI slots or the non-CLI slots. Moreover, the set of slots, where each of the two TPC command accumulations is applied, may be indicated to apparatus 910 (e.g., via apparatus 920) by a higher-layer parameter, Layer-1 signaling or a bitmap.

In some implementations, two UL power control loops may be defined for the DG PUSCH transmission with repetition with two open loop power control parameters provided per DG PUSCH repetition pattern. In such cases, each of the two open loop power control parameters may be applied to a specific set of slots among the CLI slots or the non-CLI slots. Moreover, the set of slots, where each of the two open loop power control parameters is applied, may be indicated to apparatus 910 (e.g., via apparatus 920) by a higher-layer parameter, Layer-1 signaling or a bitmap.

In some implementations, two TPC command accumulations are defined for the DG PUSCH transmission with repetition. In such cases, each of the two TPC command accumulations may be applied to a specific set of slots among the CLI slots or the non-CLI slots. Moreover, the set of slots, where each of the two TPC command accumulations is applied, may be indicated to apparatus 910 (e.g., via apparatus 920) by a higher-layer parameter, Layer-1 signaling or a bitmap.

In some implementations, the UL transmission may include a CG PUCCH transmission.

In some implementations, the PUCCH transmission may include a periodic PUCCH transmission. In such cases, two UL power control loops may be defined for the periodic PUCCH transmission with two open loop power control parameters. Moreover, each of the two open loop power control parameters may be applied to a specific set of slots among the CLI slots or the non-CLI slots. Furthermore, one or more sets of slots among the CLI slots or the non-CLI slots, where each of the two open loop power control parameters is applied, may be indicated to apparatus 910 (e.g., via apparatus 920) by a higher-layer parameter or a bitmap.

In some implementations, the PUCCH transmission may include a semi-persistent PUCCH transmission. In such cases, two UL power control loops may be defined for the semi-persistent PUCCH transmission with two open loop power control parameters. Moreover, each of the two open loop power control parameters may be applied to a specific set of slots among the CLI slots or the non-CLI slots. Furthermore, one or more sets of slots among the CLI slots or the non-CLI slots, where each of the two open loop power control parameters is applied, may be indicated to apparatus 910 (e.g., via apparatus 920) by a higher-layer parameter or a bitmap.

In some implementations, the PUCCH transmission may include an aperiodic PUCCH transmission. In such cases, two TPC command accumulations may be defined for the aperiodic CG PUSCH transmission with accumulation enabled. Moreover, each of the two TPC command accumulations may be applied to a specific set of slots among the CLI slots or the non-CLI slots. Furthermore, one or more sets of slots among the CLI slots or the non-CLI slots, where each of the two open loop power control parameters is applied, may be indicated to apparatus 910 (e.g., via apparatus 920) by a higher-layer parameter, Layer-1 signaling or a bitmap.

In some implementations, the PUCCH transmission may include a PUCCH transmission with repetition. In such cases, two UL power control loops may be defined for the PUSCH transmission with repetition with two open loop power control parameters provided per PUCCH repetition pattern. Moreover, each of the two open loop power control parameters may be applied to a specific set of slots among the CLI slots or the non-CLI slots. Furthermore, one or more sets of slots among the CLI slots or the non-CLI slots, where each of the two open loop power control parameters is applied, may be indicated to apparatus 910 (e.g., via apparatus 920) by a higher-layer parameter, Layer-1 signaling or a bitmap.

In some implementations, the PUCCH transmission may include a PUCCH transmission with repetition. In such cases, two TPC command accumulations may be defined for the PUCCH transmission. Moreover, each of the two TPC command accumulations may be applied to a specific set of slots among the CLI slots or the non-CLI slots. Furthermore, one or more sets of slots among the CLI slots or the non-CLI slots, where each of the two TPC command accumulations is applied, may be indicated to apparatus 910 (e.g., via apparatus 920) by a higher-layer parameter, Layer-1 signaling or a bitmap.

In some implementations, process 1000 may further involve processor 912 receiving, via transceiver 916, a bitmap via a higher-layer parameter or Layer-1 signaling. The bitmap may indicate a specific set of slots among the CLI slots or the non-CLI slots to which a respective UL power control is applied in performing the UL transmission.

FIG. 11 illustrates an example process 1100 in accordance with an implementation of the present disclosure. Process 1100 may represent an aspect of implementing various proposed designs, concepts, schemes, systems and methods described above, whether partially or entirely, including those pertaining to those described above. More specifically, process 1100 may represent an aspect of the proposed concepts and schemes pertaining to UL power control for dynamic TDD and SBFD in mobile communications. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively in a different order. Furthermore, one or more of the blocks/sub-blocks of process 1100 may be executed iteratively. Process 1100 may be implemented by or in apparatus 910 and apparatus 920 as well as any variations thereof. Solely for illustrative purposes and without limiting the scope, process 1100 is described below in the context of apparatus 910 as a UE (e.g., UE 110) and apparatus 920 as a communication entity such as a network node or base station (e.g., terrestrial network node 125 or non-terrestrial network node 128) of a network (e.g., network 130 as a 5G/NR mobile network). Process 1100 may begin at block 1110.

At 1110, process 1100 may involve processor 912 of apparatus 910 performing, via transceiver 916, an SRS transmission with TDD in an SBFD network (e.g., with apparatus 920 in network 130), including dynamic TDD and SBFD. Process 1100 may proceed from 1110 to 1120.

At 1120, process 1100 may involve processor 912 separately controlling, via transceiver 916, UL transmit powers used in performing the SRS transmission on CLI slots and on non-CLI slots.

In some implementations, the SRS transmission may include a periodic SRS transmission. In such cases, two UL power control loops may be defined for the periodic SRS transmission with two open loop power control parameters provided for the periodic SRS transmission. Moreover, each of the two open loop power control parameters may be applied to a specific set of slots among the CLI slots or the non-CLI slots. Furthermore, one or more sets of slots among the CLI slots or the non-CLI slots, where each of the two open loop power control parameters is applied, may be indicated to apparatus 910 (e.g., via apparatus 920) by a higher-layer parameter or a bitmap.

In some implementations, the SRS transmission may include a semi-persistent SRS transmission. In such cases, two UL power control loops may be defined for the semi-persistent SRS transmission with two open loop power control parameters provided for the semi-persistent SRS transmission. Moreover, each of the two open loop power control parameters may be applied to a specific set of slots among the CLI slots or the non-CLI slots. Furthermore, one or more sets of slots among the CLI slots or the non-CLI slots, where each of the two open loop power control parameters is applied, may be indicated to apparatus 910 (e.g., via apparatus 920) by a higher-layer parameter or a bitmap.

In some implementations, the SRS transmission may include an aperiodic SRS transmission. In such cases, two TPC command accumulations may be defined for the aperiodic SRS transmission with accumulation enabled. Moreover, each of the two TPC command accumulations may be applied to a specific set of slots among the CLI slots or the non-CLI slots. Furthermore, one or more sets of slots among the CLI slots or the non-CLI slots, where each of the two TPC command accumulations is applied, may be indicated to apparatus 910 (e.g., via apparatus 920) by a higher-layer parameter, Layer-1 signaling or a bitmap.

In some implementations, the SRS transmission may reuse a closed loop power control parameter for a PUSCH with two TPC command accumulations enabled. Moreover, the two TPC command accumulations for the PUSCH may be applied to the SRS transmission.

In some implementations, process 1100 may further involve processor 912 receiving, via transceiver 916, a bitmap via a higher-layer parameter or Layer-1 signaling. The bitmap may indicate a specific set of slots among the CLI slots or the non-CLI slots to which a respective UL power control is applied in performing the SRS transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of a user equipment (UE), an uplink (UL) transmission with time-division duplex (TDD) in a subband-full duplex (SBFD) network; and
separately controlling, by the processor, UL transmit powers used in performing the UL transmission on cross-link interference (CLI) slots and on non-CLI slots.

2. The method of claim 1, wherein the UL transmission comprises a configured grant (CG) physical uplink shared channel (PUSCH) transmission.

3. The method of claim 2, wherein two UL power control loops are defined for the CG PUSCH transmission with two open loop power control parameters provided per CG PUSCH configuration, wherein each of the two open loop power control parameters is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter or a bitmap.

4. The method of claim 3, wherein the bitmap is defined for UL slots or flexible slots or both the UL slots and the flexible slots, where the bitmap is provided per CG PUSCH configuration, and wherein the bitmap is indicated to the UE by higher-layer parameters or Layer-1 signaling.

5. The method of claim 1, wherein the UL transmission comprises a dynamic grant (DG) physical uplink shared channel (PUSCH) transmission with or without repetition.

6. The method of claim 5, wherein two transmit power control (TPC) command accumulations are defined for the DG PUSCH transmission without repetition and with accumulation enabled, wherein the TPC command accumulations for the DG PUSCH are reused in a sounding reference signal (SRS) transmission in an event that a closed loop power control parameter is applied to the SRS transmission, wherein each of the two TPC command accumulations is applied to a specific set of slots among the CLI slots or the non-CLI slots, and wherein the set of slots, where each of the two TPC command accumulations is applied, is indicated to the UE by a higher-layer parameter, Layer-1 signaling or a bitmap.

7. The method of claim 5, wherein two UL power control loops are defined for the DG PUSCH transmission with repetition with two open loop power control parameters provided per DG PUSCH repetition pattern, wherein each of the two open loop power control parameters is applied to a specific set of slots among the CLI slots or the non-CLI slots, and wherein the set of slots, where each of the two open loop power control parameters is applied, is indicated to the UE by a higher-layer parameter, Layer-1 signaling or a bitmap.

8. The method of claim 5, wherein two transmit power control (TPC) command accumulations are defined for the DG PUSCH transmission with repetition, wherein each of the two TPC command accumulations is applied to a specific set of slots among the CLI slots or the non-CLI slots, and wherein the set of slots, where each of the two TPC command accumulations is applied, is indicated to the UE by a higher-layer parameter, Layer-1 signaling or a bitmap.

9. The method of claim 1, wherein the UL transmission comprises a physical uplink control channel (PUCCH) transmission, wherein the PUCCH transmission comprises a periodic PUCCH transmission, wherein two UL power control loops are defined for the periodic PUCCH transmission with two open loop power control parameters, wherein each of the two open loop power control parameters is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter or a bitmap.

10. The method of claim 1, wherein the UL transmission comprises a physical uplink control channel (PUCCH) transmission, wherein the PUCCH transmission comprises a semi-persistent PUCCH transmission, wherein two UL power control loops are defined for the semi-persistent PUCCH transmission with two open loop power control parameters, wherein each of the two open loop power control parameters is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter or a bitmap.

11. The method of claim 1, wherein the UL transmission comprises a physical uplink control channel (PUCCH) transmission, wherein the PUCCH transmission comprises an aperiodic PUCCH transmission, wherein two transmit power control (TPC) command accumulations are defined for the aperiodic CG PUSCH transmission with accumulation enabled, wherein each of the two TPC command accumulations is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter, Layer-1 signaling or a bitmap.

12. The method of claim 1, wherein the UL transmission comprises a physical uplink control channel (PUCCH) transmission, wherein the PUCCH transmission comprises a PUCCH transmission with repetition, wherein two UL power control loops are defined for the PUSCH transmission with repetition with two open loop power control parameters provided per PUCCH repetition pattern, wherein each of the two open loop power control parameters is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter, Layer-1 signaling or a bitmap.

13. The method of claim 1, wherein the UL transmission comprises a physical uplink control channel (PUCCH) transmission, wherein the PUCCH transmission comprises a PUCCH transmission with repetition, wherein two transmit power control (TPC) command accumulations are defined for the PUCCH transmission, wherein each of the two TPC command accumulations is applied to a specific set of slots among the CLI slots or the non-CLI slots, and wherein one or more sets of slots among the CLI slots or the non-CLI slots, where each of the two TPC command accumulations is applied, is indicated to the UE by a higher-layer parameter, Layer-1 signaling or a bitmap.

14. The method of claim 1, further comprising:
receiving, by the processor, a bitmap via a higher-layer parameter or Layer-1 signaling,
wherein the bitmap indicates a specific set of slots among the CLI slots or the non-CLI slots to which a respective UL power control is applied in performing the UL transmission.

15. A method, comprising:
performing, by a processor of a user equipment (UE), a sounding reference signal (SRS) transmission with time-division duplex (TDD) in a subband-fullduplex (SBFD) network; and
separately controlling, by the processor, uplink (UL) transmit powers used in performing the SRS transmission on cross-link interference (CLI) slots and on non-CLI slots.

16. The method of claim 15, wherein the SRS transmission comprises a periodic SRS transmission, wherein two UL power control loops are defined for the periodic SRS transmission with two open loop power control parameters provided for the periodic SRS transmission, wherein each of the two open loop power control parameters is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter or a bitmap.

17. The method of claim 15, wherein the SRS transmission comprises a semi-persistent SRS transmission, wherein two UL power control loops are defined for the semi-persistent SRS transmission with two open loop power control parameters provided for the semi-persistent SRS transmission, wherein each of the two open loop power control parameters is applied to a specific set of slots among the CLI slots or the non-CLI slots, and wherein one or more sets of slots among the CLI slots or the non-CLI slots, where each of the two open loop power control parameters is applied, is indicated to the UE by a higher-layer parameter or a bitmap.

18. The method of claim 15, wherein the SRS transmission comprises an aperiodic SRS transmission, wherein two transmit power control (TPC) command accumulations are defined for the aperiodic SRS transmission with accumulation enabled, wherein each of the two TPC command accumulations is applied to a specific set of slots among the CLI slots or the non-CLI slots, and wherein one or more sets of slots among the CLI slots or the non-CLI slots, where each of the two TPC command accumulations is applied, is indicated to the UE by a higher-layer parameter, Layer-1 signaling or a bitmap.

19. The method of claim 15, wherein the SRS transmission reuses a closed loop power control parameter for a physical uplink shared channel (PUSCH) with two transmit power control (TPC) command accumulations enabled, and wherein the two TPC command accumulations for the PUSCH is applied to the SRS transmission.

20. The method of claim 15, further comprising:
receiving, by the processor, a bitmap via a higher-layer parameter or Layer-1 signaling,
wherein the bitmap indicates a specific set of slots among the CLI slots or the non-CLI slots to which a respective UL power control is applied in performing the SRS transmission.
